(19) United States
(12) Patent Application Publication
(10) Pub. No.: US 2004/0006747 A1
(43) Pub. Date: Jan. 8, 2004

(54) Electronic publishing system and method

(76) Inventor: Joseph C. Tyler, Saratoga Springs, NY (US)

Correspondence Address: HOFFMAN WARNICK & D'ALESSANDRO, LLC, 3 E-COMM SQUARE, ALBANY, NY, 12207

(21) Appl. No.: 10/603,709

(22) Filed: Jun. 25, 2003

Related U.S. Application Data
(63) Continuation-in-part of application No. 09/524,411, filed on Mar. 13, 2000.

(51) Int. Cl. G06F 17/21

(52) U.S. Cl. 715/530

(57) ABSTRACT

An electronic publishing system for efficiently and creatively disseminating information. In particular, the electronic publishing system includes: (1) a data collection interface for collecting user data from users of websites; (2) a database for storing the user data; (3) a publisher interface system to allow publisher to create an original message specification; and (4) a message builder for composing and sending an informational message according to the message specification. The electronic publishing system allows website publishers to selectively distribute information to pre-determined users of their websites in creative formats without having to maintain mailing lists. Further, the electronic publishing system allows website publishers to assess whether the information is likely to be flagged as spam.

### REFERENCE TO PRIOR APPLICATION

This application is a continuation-in-part of co-pending U.S. application Ser. No. 09/524,411, filed on Mar. 13, 2000 and incorporated herein by reference.

### BACKGROUND OF THE INVENTION

1. Technical Field

The present invention generally relates to an electronic publishing system and method, and more particularly to a system and method for electronically publishing targeted information to designated users or subscribers of participating websites.

2. Background Art

As today's technology increases, the efficient dissemination of information over the world wide web becomes more vital to commercial success in the marketplace. However, many website users/subscribers are concerned over the problem of receiving unwanted information. Many websites today attempt to collect user data (e.g. electronic mail addresses and/or demographics), which can then be used to publish material back to the users. For the website publisher, this is an extremely time consuming and potentially expensive process. Existing mean of delivering information typically involve the maintenance of a cumbersome mailing list or similar tool that constantly requires modification and revision. For example, a website publisher must maintain a list of recipients and their corresponding addresses (electronic mail or otherwise) and manually input information for recipients. Accordingly, each publisher must implement their own customized system and formats for publishing their information. Such a system requires either the delivery of the same message to every recipient, or the creation of separate messages for several different recipients. Moreover, due to the limitations of electronic mailing services, the message must often be sent in basic Ascii format even though some publishers may have more sophisticated capabilities such as rich text format.

Therefore, there exists a need for a system that allows for the efficient and creative delivery of information to selected or pre-determined recipients by website publishers. In addition, there exists a need for the system to eliminate the need for a publisher to maintain recipient lists or to create forms for displaying their information.

Further, concern over receiving unsolicited commercial email messages, i.e., “spam,” has resulted in users increasingly including spam filtering software such as DeerSoft, Inc.'s SpamAssassin™ on their email servers and/or individual computers. Spam filtering software seeks to automatically identify spam, and filter the messages before they are received by the user. In order to do this, spam filtering software can, for example, analyze the header, format and/or text of the message, determine if the sender is on a list of known spammers, etc.

However, spam filtering software frequently incorrectly identifies email messages that have been requested by a user as spam. This results in users never receiving messages from a website publisher that were requested by the user. As a result, there exists a further need for a system that allows a website publisher to determine if and/or modify an email message that is likely to be improperly filtered by spam filtering software before delivering the message to selected or pre-determined recipients.

### SUMMARY OF THE INVENTION

The present invention overcomes the problems associated with existing systems by providing a system and method for electronically publishing information. In particular, the system collects data from users of websites and separately stores the user data for each website in a database. When a website publisher desires to send a message to particular users of his/her website, the publisher will access the system and create an original message specification. The message specification allows the publisher to: (1) select a template in which the message will be displayed; (2) designate recipient criteria to determine which website users will receive the message; (3) designate a time for delivery of the message; and (4) input the information that will comprise the message. The likelihood that a message resulting from the message specification would be flagged as spam can be assessed. Based on this assessment, the website publisher may adjust one or more attributes of the message prior to delivering the message.

The designation of recipient criteria eliminates the need for the publisher to maintain recipient/address lists because the publisher will merely designate criteria (e.g. demographical and interest data) of the users that should receive the message. The electronic publishing system will compare the designated criteria to the user data stored in the database for the particular website. Only users whose data matches the designated criteria will receive the message. In addition, although the system allows a publisher to select from a plurality of creative templates for the display of information, the templates are customizable by each publisher.

According to a first aspect of the present invention, an electronic publishing system is provided, which includes: (1) a data collection interface for collecting user data from users of a plurality of websites; (2) a database for separately storing collected user data for each website; (3) a publisher interface that allows a publisher for each website to create a specification associated with the publisher's website, wherein the publisher interface includes: (a) a mechanism for selecting a template from a plurality of templates; (b) a mechanism for inputting information; (c) a mechanism for designating a recipient criteria; (d) a scheduling mechanism for establishing a delivery time; and (4) a message builder that accesses a server and generates a message for delivery to a targeted group of website users based on the message specification created by the publisher of the associated website.

According to a second aspect of the present invention, a program product for electronically publishing information is provided, which includes a recordable media having: (1) a system for separately storing user data collected from users of a plurality of websites; (2) a publishing system, wherein the publishing system allows a publisher of each website to create a message specification associated with the publisher's website, including: (a) a system for inputting information; (b) a system for selecting a template from a plurality of templates in which the information will be displayed; (c) a system for designating a recipient criteria; and (d) a system for designating a time of delivery.

According to a third aspect of the present invention, a computer system for electronically publishing information is provided, which includes: (1) a processor; (2) a computer system memory; (3) an interface; and (4) a software product stored on the computer system memory and executable by the processor, wherein the software product comprises: (a) a system for separately storing user data collected from users of a plurality of websites; (b) a publishing system, wherein the publishing system allows a publisher of each website to create a message specification associated with the publisher's website, including: (i) a system for inputting information; (ii) a system for selecting a template from a plurality of templates; (iii) a system for designating a recipient criteria; and (iv) a system for designating a time of delivery.

According to a fourth aspect of the present invention, a method for electronically publishing information is provided, which includes the steps of: (1) collecting user data from users of a plurality of websites with a user data collection interface; (2) storing the user data in a database; (3) providing a publisher interface system whereby a plurality of publishers can create a message specification by: (a) inputting information, wherein the information includes story content and advertisements; (b) selecting a template from a plurality of templates, wherein the information will be displayed in the selected template; (c) designating a recipient criteria; and (d) designating a time for delivery.

According to a fifth aspect of the present invention, a method for electronically publishing information is provided, which includes: (1) accessing a detail window to designate message details, including: (a) selecting a time for delivery for the information; (b) selecting a template from a plurality of templates; (2) accessing a news window to input the information and designate news details, including: (a) selecting a title for the information; (b) inputting story content into a text box; and (c) selecting a target recipient criteria.

According to a sixth aspect of the present invention, an electronic publishing system, comprising: a publisher interface that allows a publisher of a website to create a message specification associated with the website; and a message builder that generates a message for delivery to a targeted group of users of the website based on the message specification, wherein the message builder includes: a formatter for generating the message; and a spam tester for assessing whether the message is likely to be flagged as spam.

According to a seventh aspect of the present invention, a method of electronically publishing information, comprising: creating a message specification associated with a website; generating a message based on the message specification; assessing whether the message is likely to be flagged as spam; and delivering the message to a targeted group of users.

According to an eighth aspect of the present invention, a program product stored on a recordable media for electronically publishing information, the program product comprising: program code configured to allow a publisher of a website to create a message specification associated with the website; program code configured to generate a message for delivery to a targeted group of users of the website based on the message specification; and program code configured to assess whether the message is likely to be flagged as spam.

It is therefore an advantage of the present invention to provide a system and method of electronically publishing information. It is a further advantage of the present invention to provide a system that allows a user to selectively, efficiently and creatively deliver information without having to maintain recipient/mailing lists or the like. It is yet another advantage of the present invention to provide a system that allows a publisher to determine whether the information is likely to be filtered by spam filtering software prior to sending the information.

The preferred embodiment of the present invention is designed to solve the problems herein described and other problems not discussed, which are discoverable by a skilled artisan.

### BRIEF DESCRIPTION OF THE DRAWINGS

These and other features and advantages of this invention will be more readily understood from the following detailed description of the various aspects of the invention taken in conjunction with the accompanying drawings in which:

FIG. 1 depicts a block diagram of a computer system having an electronic publishing system in accordance with the present invention;

FIG. 2 depicts a block diagram of an electronic publishing system in accordance with the present invention;

FIG. 3 depicts a block diagram of a message builder, server, and database in accordance with the present invention;

FIG. 4 depicts a block diagram of an electronic message being delivered to website users in accordance with the present invention.

FIG. 5 depicts administrative options of a publisher interface system in accordance with the present invention;

FIG. 6 depicts news topics of a publisher interface system in accordance with the present invention;

FIG. 7 depicts a news topic edit window of a publisher interface system in accordance with the present invention;

FIG. 8 depicts demographic categories of a publisher interface system in accordance with the present invention;

FIG. 9 depicts a demographic category edit window of a publisher interface system in accordance with the present invention;

FIG. 10 depicts personal topics of a publisher interface system in accordance with the present invention;

FIG. 11 depicts a personal topic edit window of a publisher interface system in accordance with the present invention;

FIG. 12 depicts a target recipient criteria/groups of a publisher interface system in accordance with the present invention;

FIG. 13 depicts a target recipient criteria/group edit window of a publisher interface system in accordance with the present invention;

FIG. 14 depicts a mailing window of a publisher interface system in accordance with the present invention;

FIG. 15 depicts a detail window of a publisher interface system in accordance with the present invention;

FIG. 16 depicts a news window of a publisher interface system in accordance with the present invention;

FIG. 17 depicts an advertisement window of a publisher interface system in accordance with the present invention;

FIG. 18 depicts an un-subscription system in accordance with the present invention;

FIG. 19 depicts a flow chart of a first method in accordance with the present invention;

FIG. 20 depicts a flow chart of a second method in accordance with the present invention;

FIG. 21 depicts a portion of an alternative embodiment of the electronic publishing system shown in FIG. 2;

FIG. 22 depicts a results window of an illustrative spam tester in accordance with the present invention; and

FIG. 23 depicts a flow chart of a third method in accordance with the present invention.

It is noted that the drawings of the invention are not to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements between the drawings.

### DETAILED DESCRIPTION OF THE INVENTION

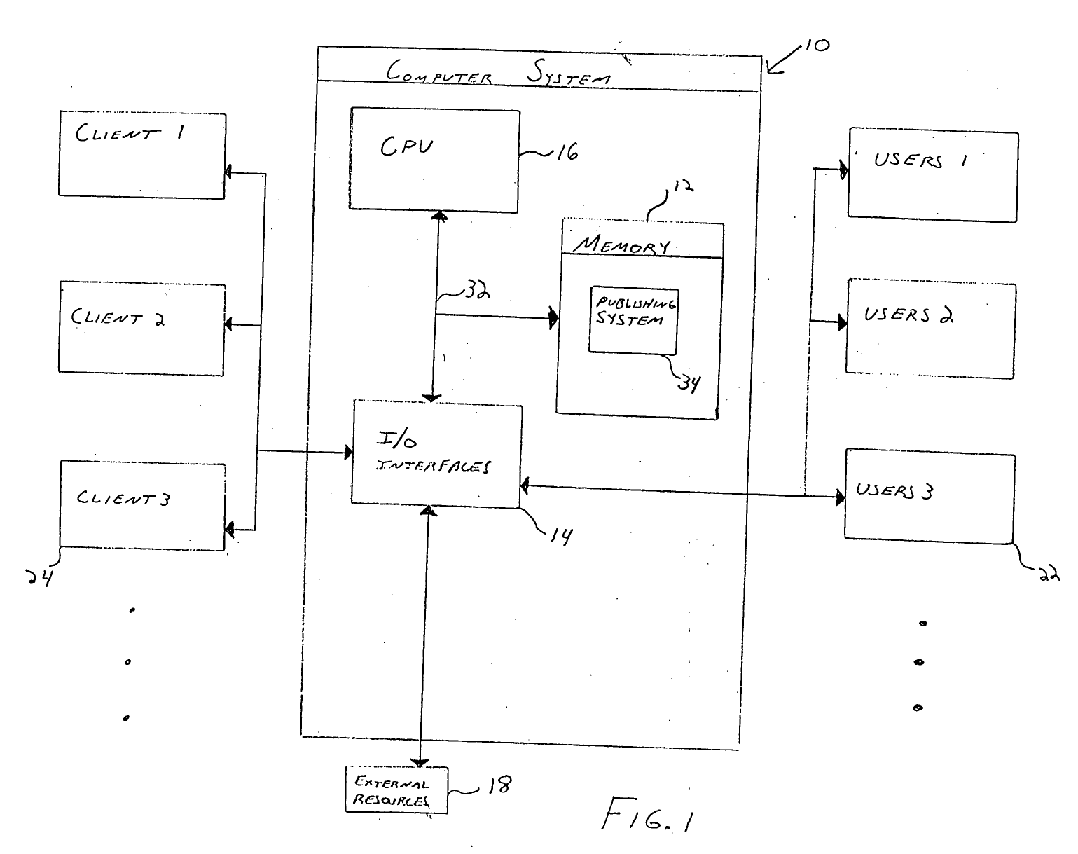

Referring now to FIG. 1, a computer system 10 depicting an embodiment of the present invention is shown comprising memory 12, input/output interfaces 14, a central processing unit (CPU) 16, external resources 18, and bus 32. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms. CPU 16 may likewise comprise a single processing unit, or be distributed across one or more processing units in one or more locations, e.g., on a client and server. I/O interfaces 14 may comprise any system for exchanging information from an external source. External resources 18 may comprise any known type of external device, including a CRT, LED screen, hand held device, keyboard, mouse, voice recognition system, speech output system, printer, facsimile, pager, etc. Bus 32 provides a communication link between each of the components in the computer system 10 and likewise may comprise any known type of transmission link, including electrical, optical, radio, etc. In addition, although not shown, additional components, such as cache memory, communication systems, system software, etc., may be incorporated into computer system 10.

It is understood that the present invention can be realized in hardware, software, or a combination of hardware and software. The computer system 10 according to the present invention can be realized in a centralized fashion in a single computer, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when loaded and executed, controls the computer system 10 such that it carries out the methods described herein. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

Stored in memory 12 is electronic publishing system 34. Also shown are clients 24, which generally are associated with websites and, and users 22 that visit the websites and desire to receive information from the corresponding website publishers (also referred to as subscribers). Electronic publishing system 34, which is described in further detail below, comprises a software program that provides a central means for a plurality of website publishers or clients 24 to publish information to targeted recipients or website users 22.

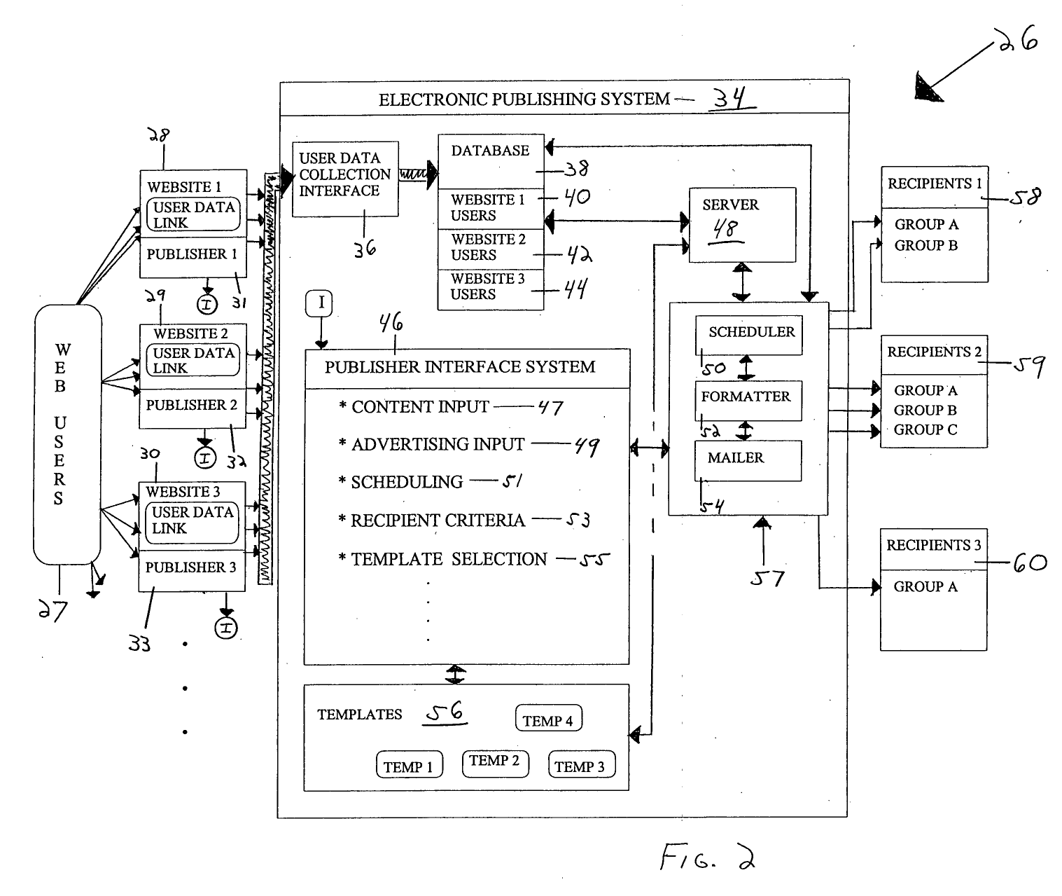

Referring now to FIG. 2, the electronic publishing environment 26 of the present invention is shown. Specifically, the electronic publishing environment 26 generally includes: (1) websites 28-30; (2) website publishers 31-33; (3) website users 27 (3) electronic publishing system 34; and (5) information recipients 58-60. It should be appreciated that although FIG. 2 and the corresponding description shows three websites, publishers, and recipient groups, more or fewer could exist.

The electronic publishing system 34 allows a website publisher 31-33 to disseminate information to selected users of the associated website both efficiently and creatively. It should be understood that although information described herein pertains to story content and advertisements, other forms of information can be disseminated. The electronic publishing system 34 operates as follows. First, users 27 of the websites 28-30 will visit their corresponding websites. Then, those users 27 who wish to receive information from the publishers 31-33 of the websites 28-30 (i.e., subscribers) will have user data collected therefrom by user data collection interface 36. The user data collection interface 36 preferably resides within the electronic publishing system 34 at a predefined URL (uniform resource locator). The user data collection interface 36 will generally comprise a screen where users can input data (e.g., e-mail address, etc.). Although the user data collected is generally related to demographics, interests, and message preferences, it should be appreciated that any form of data designated by the publishers can be collected.

The user data is then separately stored for each website 28-30 in the database 38. In particular, the website user data 40 from website 28 is stored separately from the website user data 42 from website 29. As shown, all user data, such as the address and identity of the users, is stored within the remote publishing system 34. This eliminates the need for the publishers 31-33 to separately maintain this data. When publishers 31-33 wish to send information to selected users of their websites 28-30, they will access the publisher interface system 46 and create a message specification for sending the information. The message specification allows the publishers 28-30 to generate a customized informational message and selectively send the message to pre-determined or designated users/subscribers, hereinafter recipient groups.

As shown in FIG. 2, a publisher 31 can access the publisher interface system 46 and input both the story content 47 and advertisements 49 that are intended to reach the desired recipients 58-60. Along with inputting the information, the publisher 31 can schedule a date and time for delivery of the message(s) 51, select a template 55 from a plurality of templates 56, and designate a recipient criteria 53 for determining the specific users of the publisher's corresponding websites that will receive the information. FIG. 2 shows only a portion of the interface characteristics that the publisher 31 can select. It should be appreciated that other characteristics can be utilized, as will be described in more detail below.

Once the publisher 31 has completed the process of creating a message specification, the message is generated and delivered to the appropriate users according to their specification, by a message builder 57. In general, the message builder includes a scheduler 50, a formatter 52 and a mailer 54. Interacting with the message builder 57 is a server 48, which, inter alia, accesses the templates 56 and the database 38.

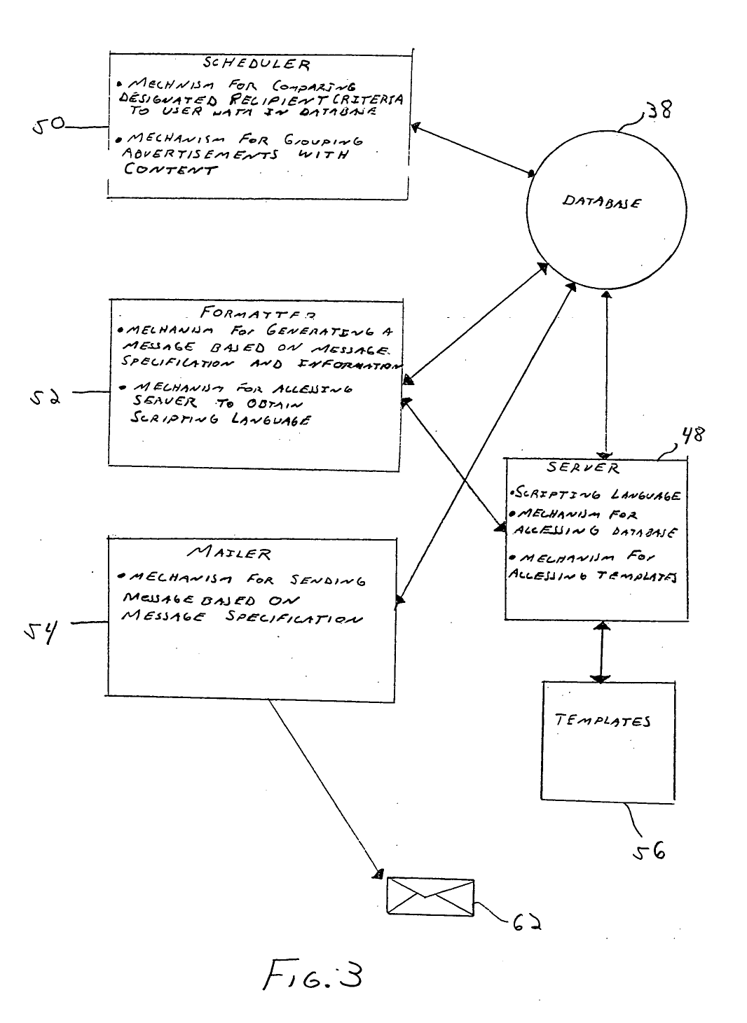

Referring now to both FIGS. 2 and 3, the message builder 57, database 38, and the server 48 are shown in greater detail. As depicted, scheduler 50 will group the inputted advertisements 49 with the inputted story content 47 and access the database 38 to compare the designated recipient criteria 53 with the user data stored therein. This comparison will ensure that only users whose data matches the criteria designated by the publisher 31 will receive the informational message 62. Accordingly, both content and advertisements can be directed to relevant recipients. For example, if a publisher wishes an information message to be received by users/subscribers that are interested in sports AND that are under the age of 18, this recipient criteria will be designated for both the story content and the advertisements.

The formatter 52 will generate the message 62 according to the specification created by the publisher 31-33. Specifically, the formatter will access the server 48 to obtain the scripting language necessary for generating the message 62. As this occurs, the server 48 accesses the templates 56 and transfers the template selected by the publisher 31 (via the template election system 55) to the formatter 52 so that the message 62 can be displayed in the desired format. Then, the mailer 54 delivers the message 62 to the specific recipients 58 according to the means selected by the publishers 31 and at the selected time and date 51. It should be appreciated that the means for delivering is also selected by the publisher 31 and is preferably an electronic mail message. However, it should be understood that other means for delivering the message 62 exist. For example, the message 62 can be faxed, sent to a pager device, or sent via any other known means of wireless communication such as to a personal digital assistant (PDA). Moreover, it should be appreciated that the publishers will designate the various means for delivery that the publisher supports. From the designated means for delivery, the users will select the means they prefer to receive informational messages, at the user data collection interface 36.

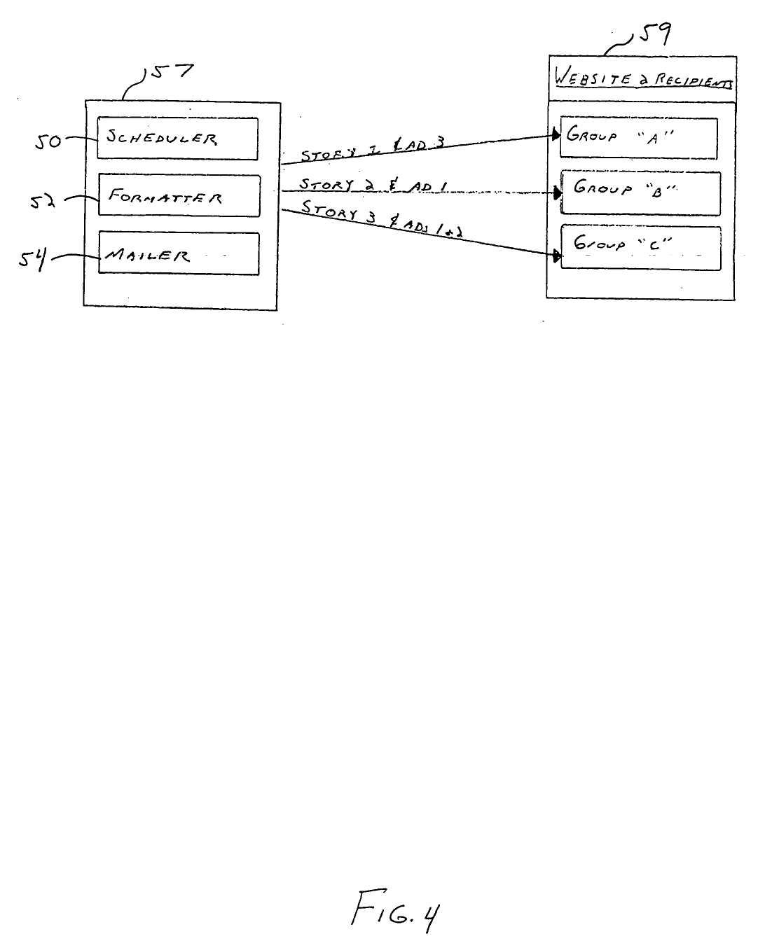

FIG. 4 shows one example of information being selectively delivered to designated groups of recipients. Specifically, the message builder 57 and website 2 recipients 59 are shown. If the publisher desires certain stories and/or advertisements to be directed to specific recipient groups, the publisher could designate a recipient criteria that matches the intended recipient group. For example, if the website 2 publisher desires story 1 and advertisement 1 to reach only group “A” of recipients, they could do so by creating/customizing a recipient criteria that precisely matches this group, as will be described in further detail below. Then, the publisher would designate the created criteria at the publisher interface system 46 for both the story content and the advertisement. The publisher could then target additional groups (e.g., B and C) to receive their own set of information.

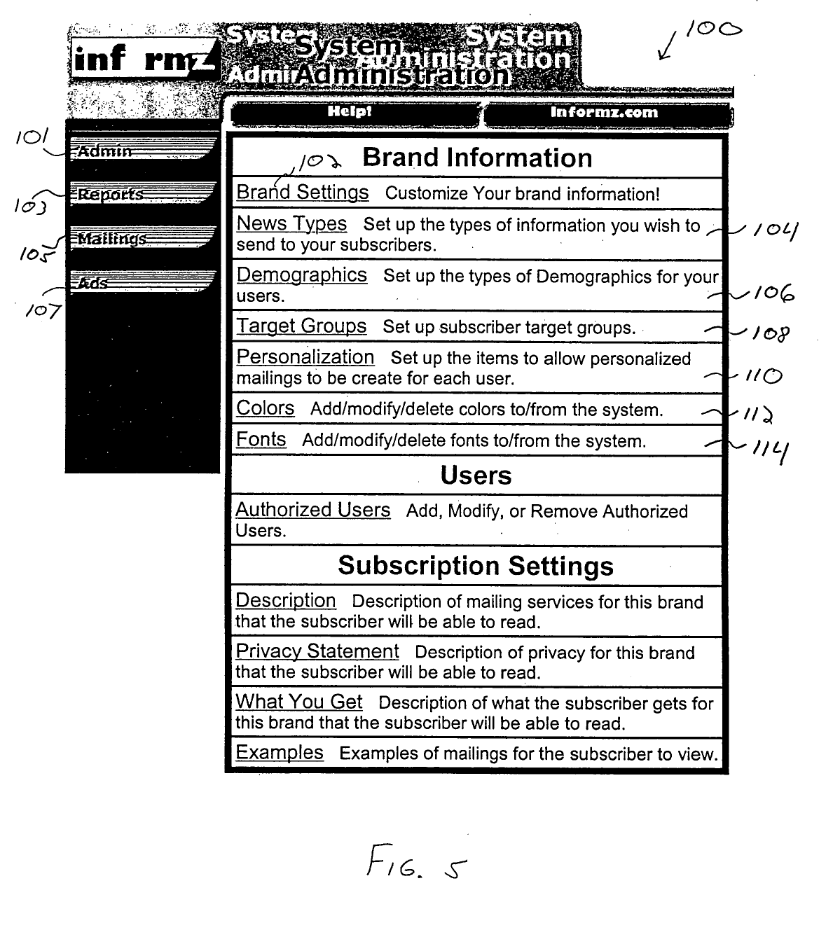

FIGS. 5-16 depict various “screen-shots” taken from the publisher interface system 46 described above. Referring first to FIG. 5, an administration window 100 is shown (upon selecting admin tab 101). From this window 100, the publisher can create the message specification necessary for distributing their information in the form of an electronic mailing. The report tab 103 allows the publisher to view data regarding the users of their website and any mailings that have been sent. The mailing tab 105 allows the publisher to build and selectively distribute an informational mailing. The advertisement tab 107 allows the publisher to add or delete any advertisements that may accompany their mailings.

Also included in the administration window 100 are several links in which the publisher can: (1) determine which information will be collected from users of their website; (2) create or modify target recipient criteria/groups so that only certain users will receive specified messages; and (3) add, modify, or delete various formatting characteristics of the messages.

First, the brand settings link 102, color link 112, and font link 114 allows the publisher to vary the physical appearance of their message. Specifically, the publisher can add or change the font, color, or formatting of various message features such as page headers, footers, titles, body text, section headings, table of contents, etc. It should be appreciated that the attributes listed here are not intended to be exhaustive. For example, a system could be provided with more or fewer formatting features.

The news link 104, demographic link 106, and the personalization link 110 allows the publisher to designate the types of data that is collected, at the user data collection interface 36, from website users who desire to receive the publisher's information. In particular, when a user enters the publisher's website and indicates he/she wishes to receive information, they become a subscriber and will be asked to answer queries relating to their demographics and interests. Once submitted, this data is stored in the database 38. Thus, the gathering and storage of user data is done within the electronic publishing system 34, which eliminates the publisher's need to store or maintain this data.

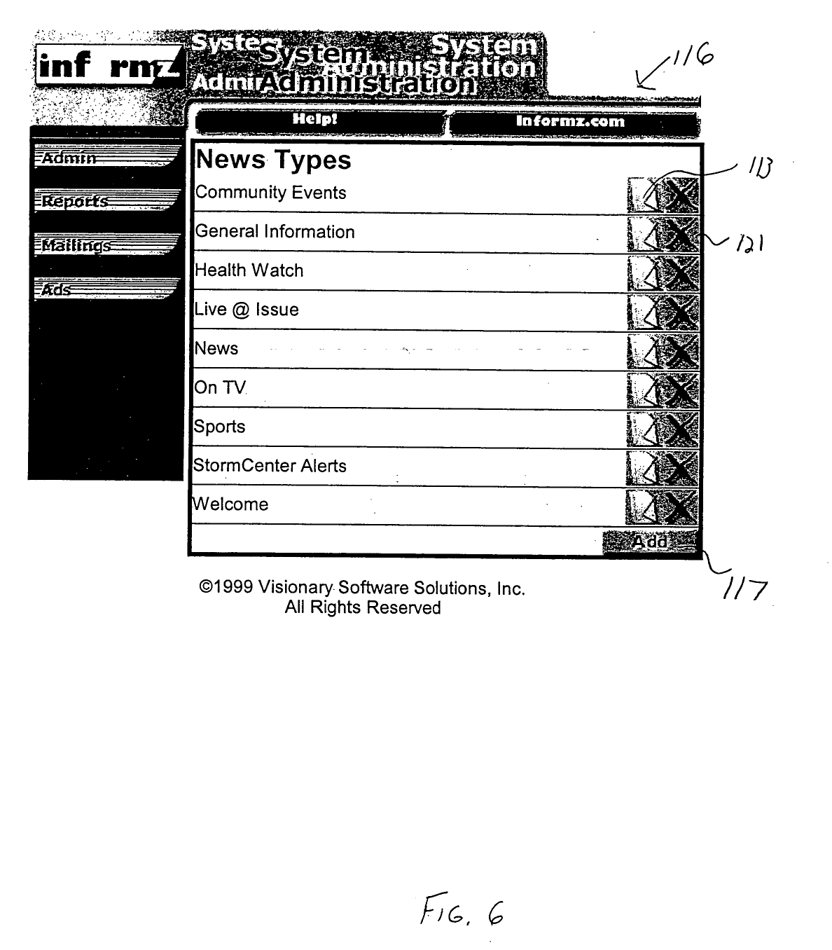

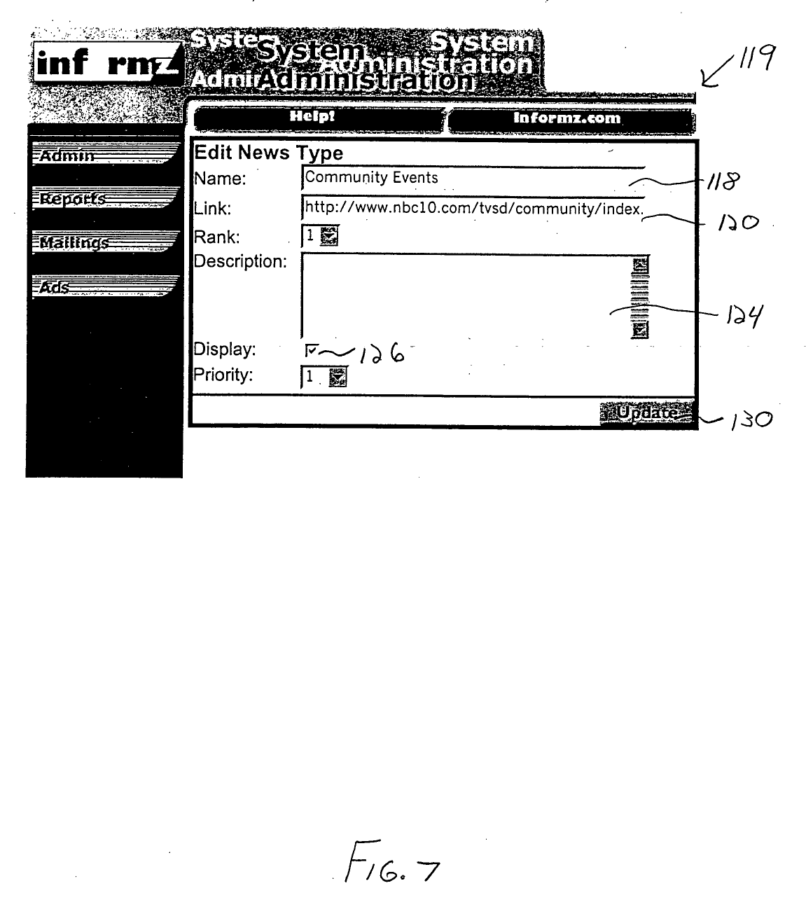

If the publisher selects the news link 104, the topic window 116 of FIG. 6 will be shown. The topic window 116 is where the publisher can designate various news topics, which users can select as being of interest. If a topic needs to be added, the publisher can select the add button 117 and access topic edit window 119, of FIG. 7. In this window, the publisher can designate a topic name 118, provide a hyperlink 120 if desired, give the users a description 124 of the types of news that pertain to this topic, and choose to display the topic 126 at the user data collection interface 36. Once all of the desired information is entered, the publisher will select the update button 130, and the newly created topic will be displayed at topic window 116. If the publisher needs to modify an existing topic, they will select the modify button 113 (FIG. 6) next to the corresponding topic and modify the information in a similar fashion. Similarly, when the publisher wishes to delete a particular topic, they will select the delete button 121 next to the corresponding topic.

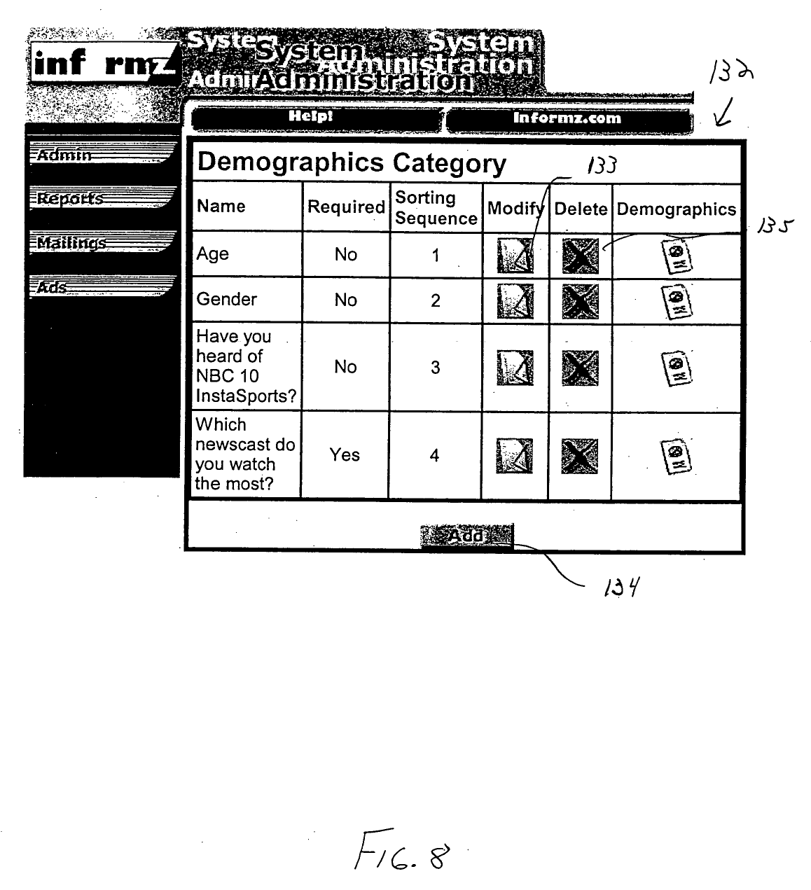

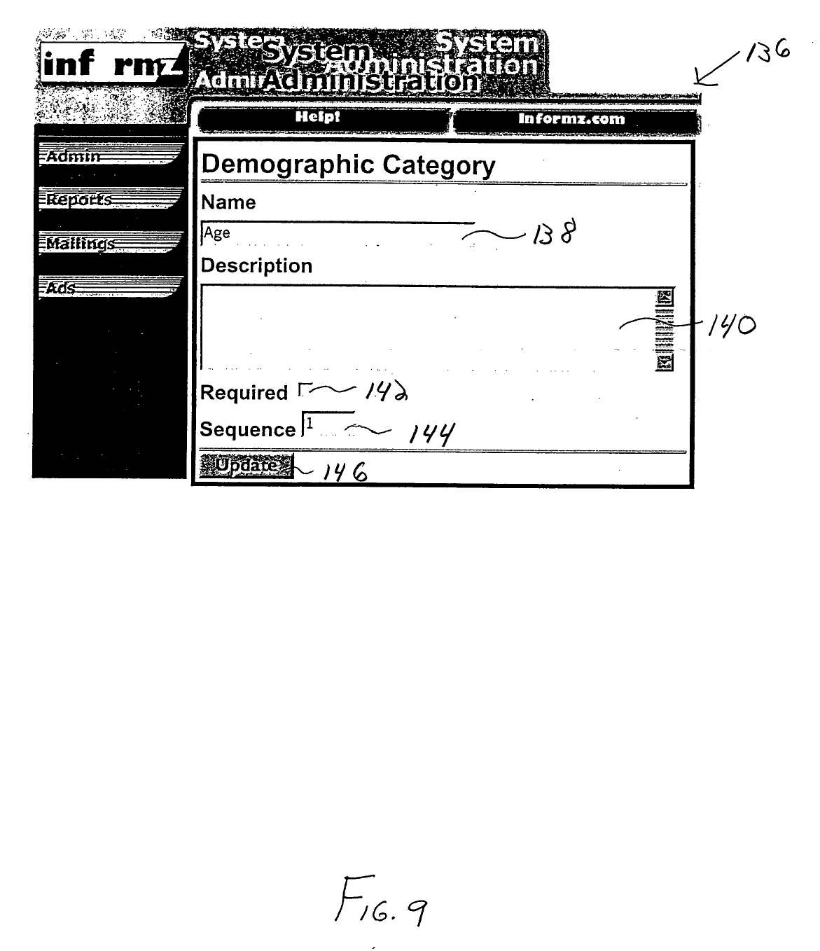

FIG. 8 depicts a demographic window 132 that is displayed when the publisher selects the demographic link 106 of FIG. 5. This window is where the publisher will create/modify the demographical and interest queries that will be used to collect additional data from website users. As shown, this particular publisher is requesting that users input their age, gender, and answer two questions. This is to help the publisher deliver messages to relevant audiences as well as to collect information regarding the publisher's programs. If the publisher wishes to add additional demographic categories or informational queries they can accomplish this by selecting the add button 134 and accessing demographic edit window 136 of FIG. 9.

Referring now to FIG. 9, the publisher can enter a name 138 for the category of information, give a description of the category 140, designate whether the users must provide this information 142 and select the sequence 144 in which the category will be listed in the demographic window 132 of FIG. 8. If the publisher wishes to list another question to be answered, they will enter the question in the description box 140. Once the category has been completed, the publisher will select the update button 146 and the category will be listed in the demographic window 132. Additionally, the publisher can modify or delete existing categories by selecting the modify 133 or delete 135 buttons (FIG. 8) for the particular category. It should be appreciated that inquiries other than those shown herein can be made by the publishers. For example, the publisher can inquire which means of delivery (e.g., e-mail, facsimile, etc.) the users desire to receive the message.

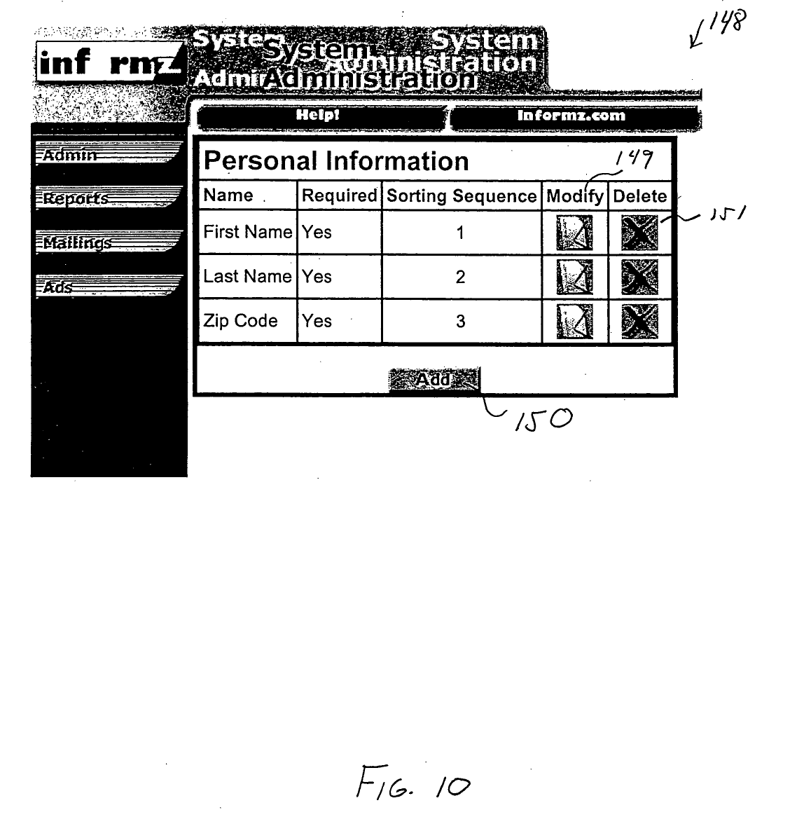

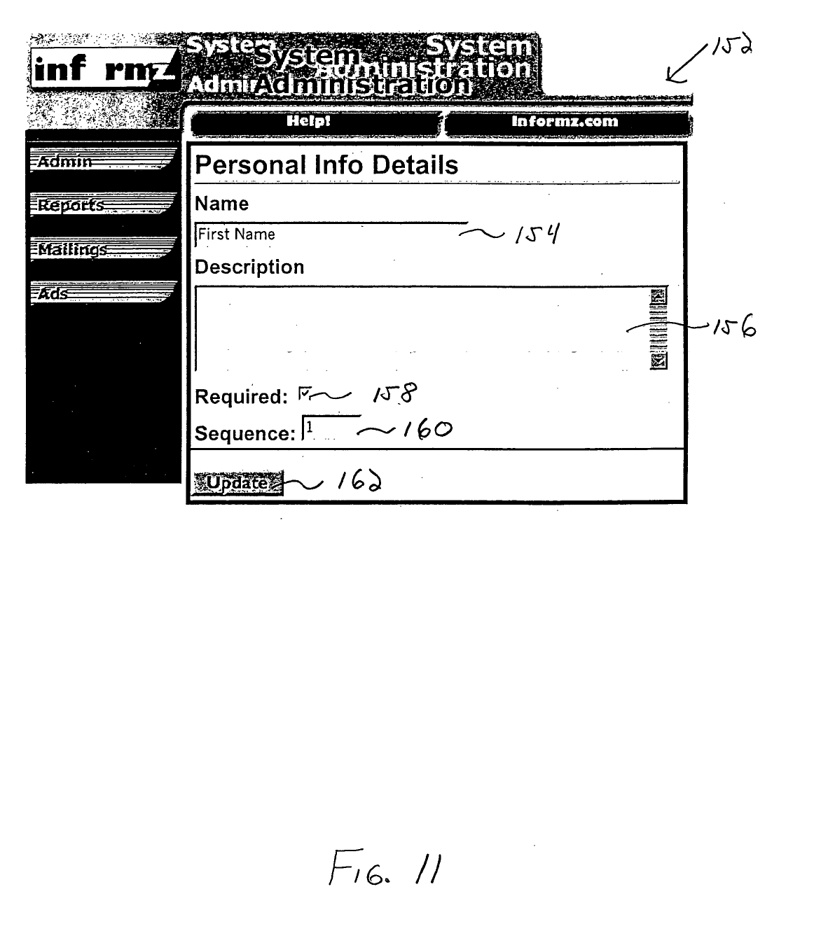

FIGS. 10 and 11 show a personal information window 148 and a personal information edit window 152 that are accessed from the personalization link 110 of FIG. 5. These windows are where other forms of personal data can be designated for collection from a user. To add a new category, the publisher will select the add button 150 and create the category, according to FIG. 11, in the same manner as described above for the demographic categories and news topics. Similarly, to modify or delete a category, the publisher will select either the modify 149 or delete 151 buttons (FIG. 10) for the corresponding personal information category.

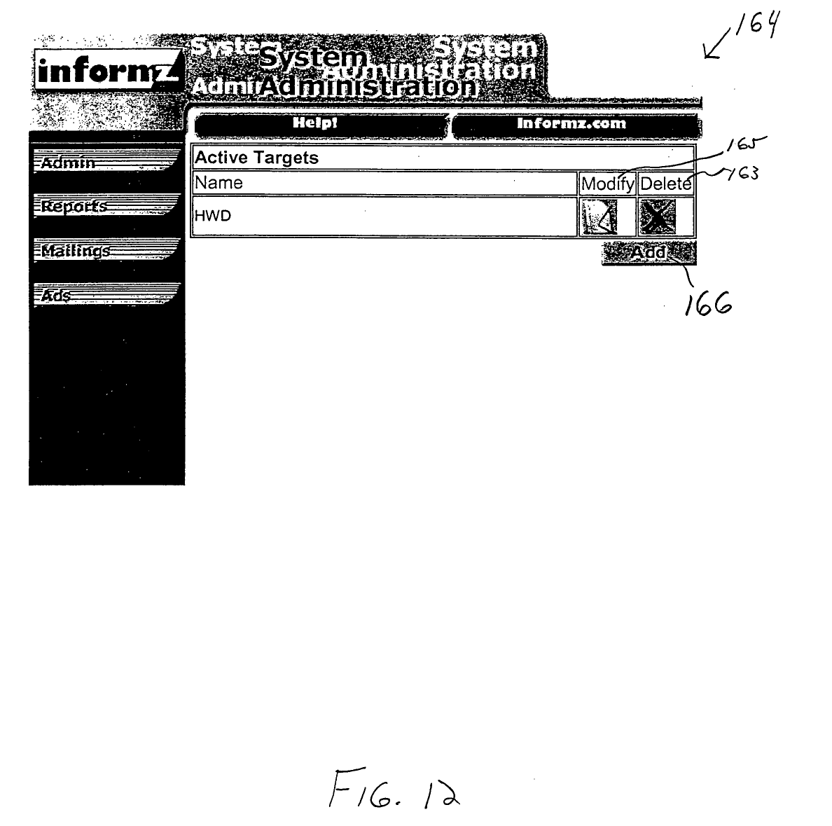

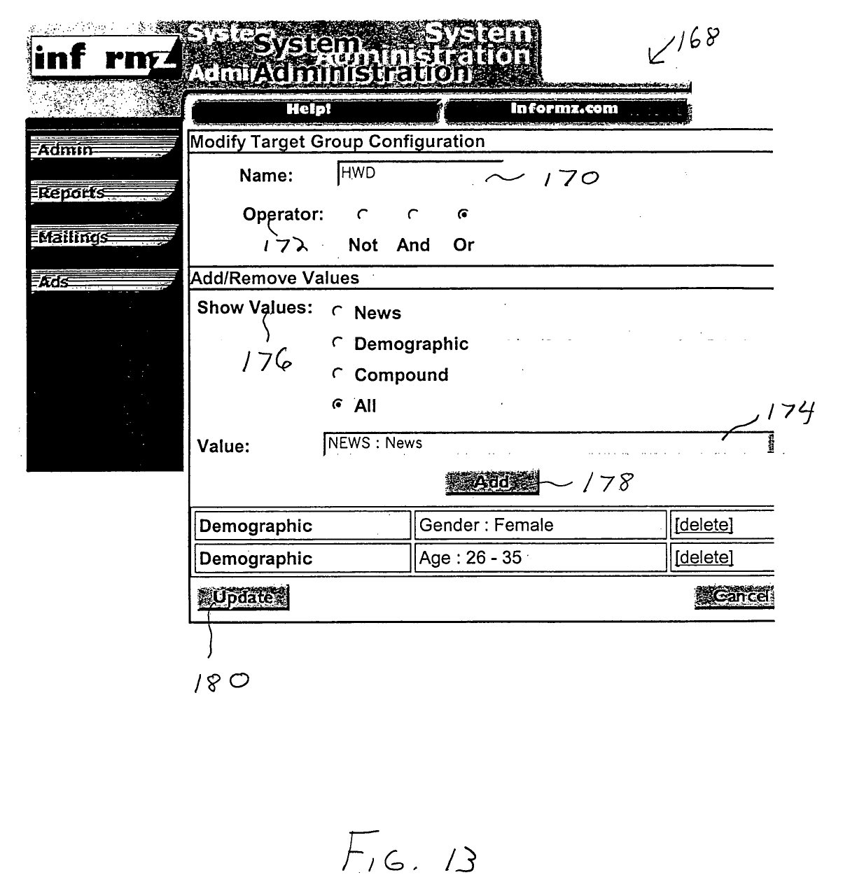

FIG. 12 shows the target window 164 that is accessed by selecting the target link 108 of FIG. 5. This is where the publisher can create or modify target recipient criteria/groups for their messages. For example, if the publisher wants to send a message that will only be received by females within the ages 26-35 OR by users who designated “news” as a topic of interest, they can do so by creating a recipient criteria/group that matches this specification. To accomplish this, the publisher will select add button 166 and the access target edit window 168 of FIG. 13. Here, the publisher can give the criteria a name 170 and select the demographic value(s) 174 that will make up the criteria. For example, the criteria entitled “HWD” currently includes females within the ages of 26-35. For the message to reach them OR users who designated “news,” the publisher will first select the “or” logical operator 172. Next, the publisher will select “news” as a value 174, and then select the add 178 button. Once the criteria is set as desired by the publisher, the update button 180 will be selected. The recipient criteria “HWD” will now include these desired values. To modify or delete a criteria, the publisher will select either the modify 165 or delete 163 button, respectively (FIG. 12).

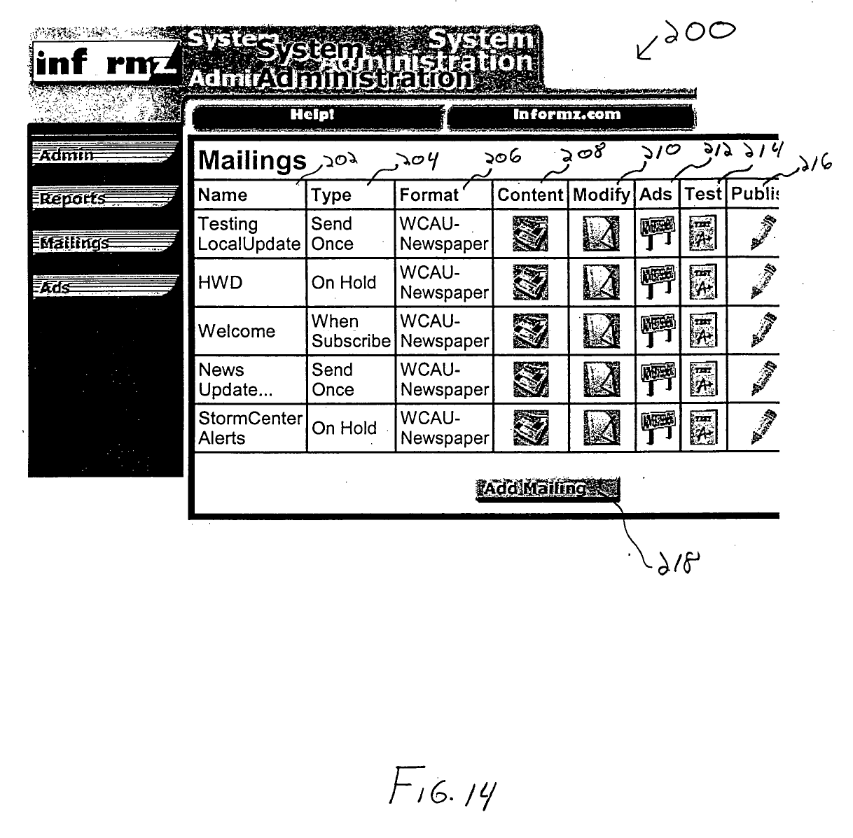

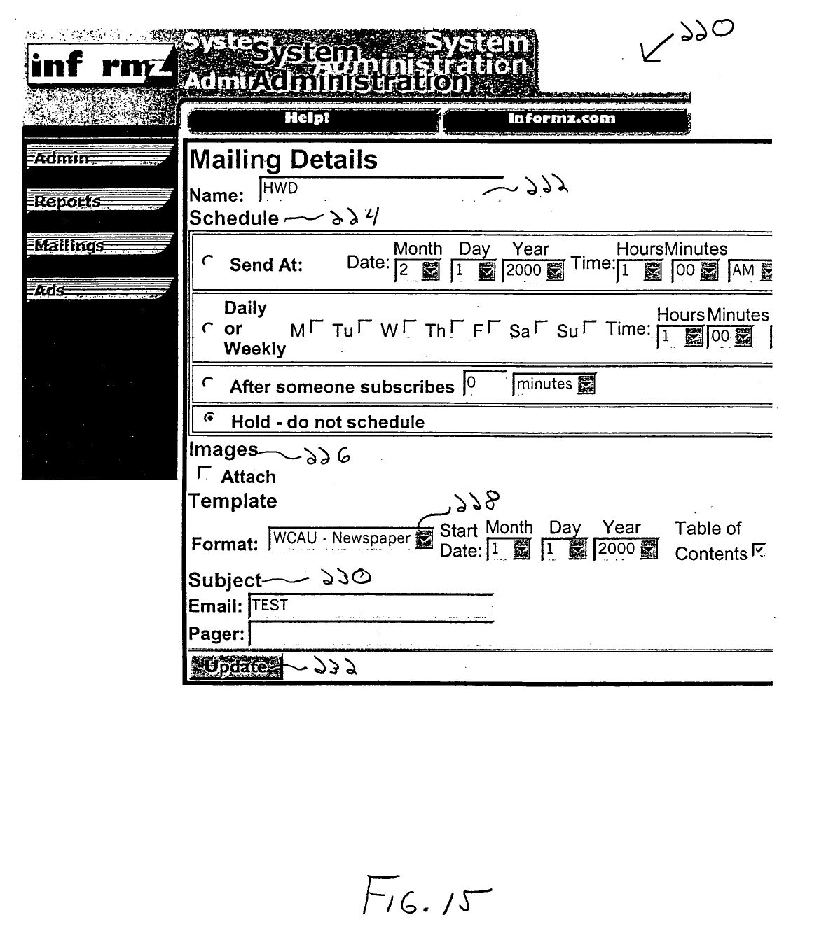

To create a mailing, the publisher will access the mailing window 200 of FIG. 14 by selecting the mailing tab 105 of FIG. 5. As shown, mailing window 200 includes multiple mailings and specifics pertaining thereto organized in rows. In particular, the specifics shown include the name 202 of the mailing, when the mailing will be sent 204, and the template in which the publisher's information will be displayed 206. The publisher can either add a new mailing by selecting the add button 218 or edit one of their existing mailings by selecting the modify button 210. In either case, the detail window 220 of FIG. 15 will be displayed. From here, the publisher can designate a name for the mail message 222, select the date and time for delivery 224 of the mail message, attach an image 226 to the message, select a template 228 for the message, and give the message a subject 230. Once all desired details have been inputted, the publisher will select the update button 232 and the details will be stored. It should be appreciated that as used throughout this disclosure, each mailing may be comprised of one or more messages.

The templates comprise predefined forms that determine how each message will appear. The templates can include daily, weekly, or monthly calendars, news letters, newspapers, or any other desirable form of presentation. Moreover, the templates are preferably presented to recipients in HTML format. However, it should be appreciated that the templates can be presented in many other formats, such as plain text or other languages. In particular, the publishers can designate the formats they will support and the users can designate their preference at the user data collection interface 36. The publishers can also customize the templates themselves by downloading a template and customizing it using any means known to those of ordinary skill in the art, such as with a scripting language or an HTML editor. Once the template is customized, it can then be uploaded back to the electronic publishing system for the publisher's use.

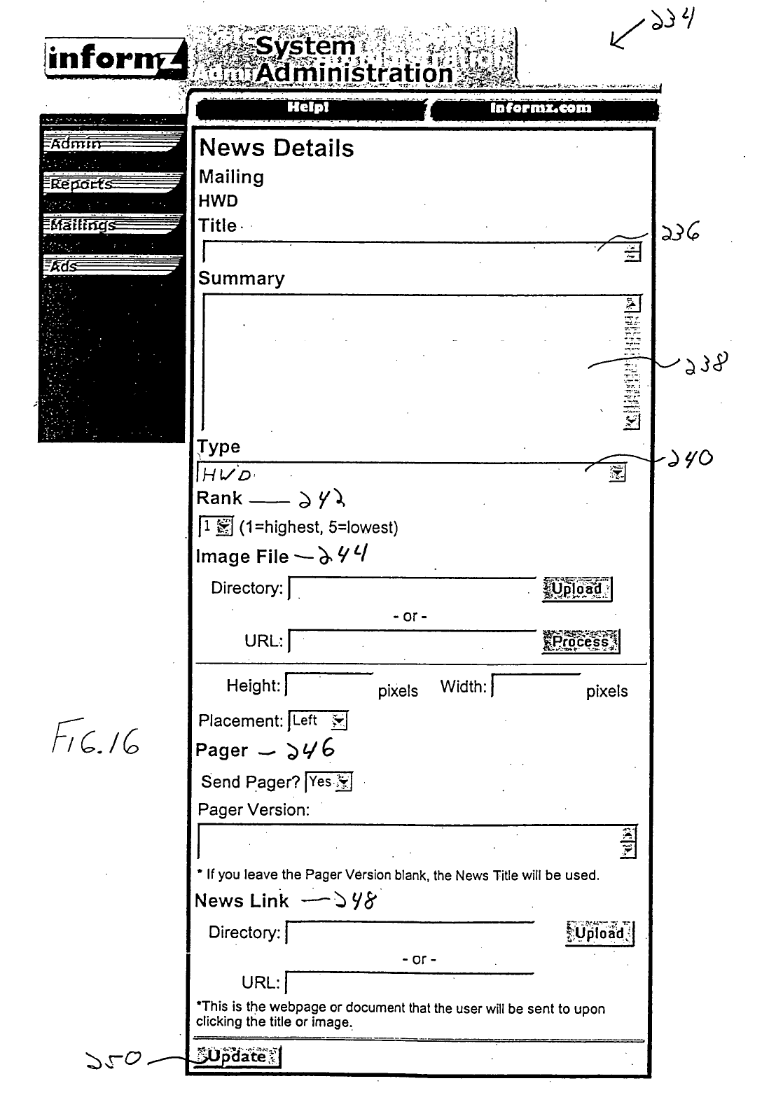

After the mailing details have been designated, the publisher can then add their story content and other news details for each message. This is accomplished by selecting the content button 208 for the corresponding mailing in the mailing window 200 of FIG. 14. This selection will display the news window 234 shown in FIG. 16.

Referring to FIG. 16, the publisher can first designate a title 236 for the message. Text box 238 is where the publisher will enter the actual story content, which can be done by cutting and pasting a story from a word processing program, by entering the story directly into the text box 238, or by any other known means. Once the story has been entered, the publisher can select the target recipient criteria 240 to determine which users will receive the message. As shown, the earlier created criteria “HWD” has been selected. Therefore, the message being created in FIG. 16, will be delivered to women within the ages 26-35 OR those users who designated “news” as an area of interest.

The publisher can also assign a rank 242 to the particular story so that if several messages appear in one mailing, they can be listed in a pre-determined/particular order. Images 244 are also attachable to the message if the publisher provides a directory or link to where the images are stored. Next, the publisher can designate whether the message is to be distributed to pager devices 246. Also, the publisher can send a hyperlink with the message so that upon access by the recipient(s), the web page corresponding to the link will be displayed. Finally, once all of the news details have been designated by the publisher, the update button 250 is selected and the message specification is stored in the database 38. It should be understood that the system can include additional details for aiding in delivering the message to the desired recipients.

This system allows several different stories/messages to be sent to different recipients in the same mailing. For example, if the publisher wanted to add a second story to the mailing, they would select the content button 208 again and access another blank news window 234. The publisher would then complete the window as before, only changing the stories, target recipients, and/or other details as desired. Therefore if the publisher had a mailing with three different stories and wanted to send the first and second stories to one target recipient group and the third story to a different target recipient group, they could do so by entering stories one and two in a first news window 234 and then designating the desired target recipient criteria/group for those stories. The third story would then be entered into a different news window 234 and the desired recipient criteria for that story would then be designated. If there was no listing for the desired target recipient criteria for either message, the publisher could created such a group by following the steps described above for FIGS. 12 and 13.

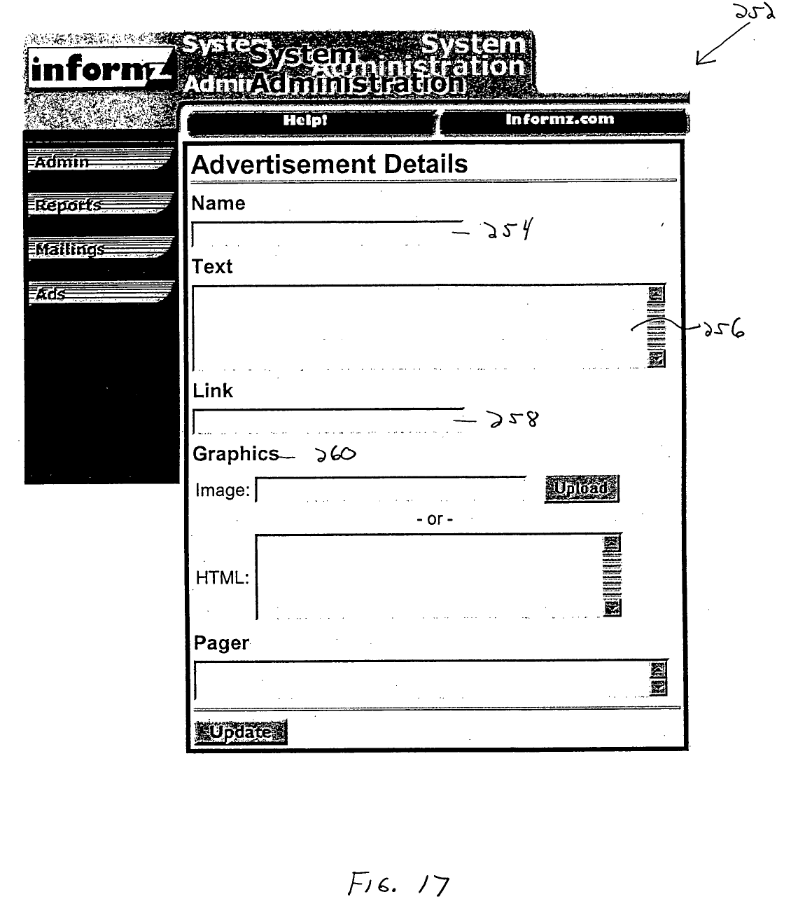

To add advertisements to the mailing, the publisher will access the advertisement window 252 shown in FIG. 17. Here the publisher can create/designate the advertisements that are desired to accompany the story content of a mailing. Specifically, advertisement window 252 allows the publisher to, inter avia, designate a name 254 for the advertisement, provide any text 256 to accompany the advertisement, and designate any graphics 260 to accompany the advertisement.

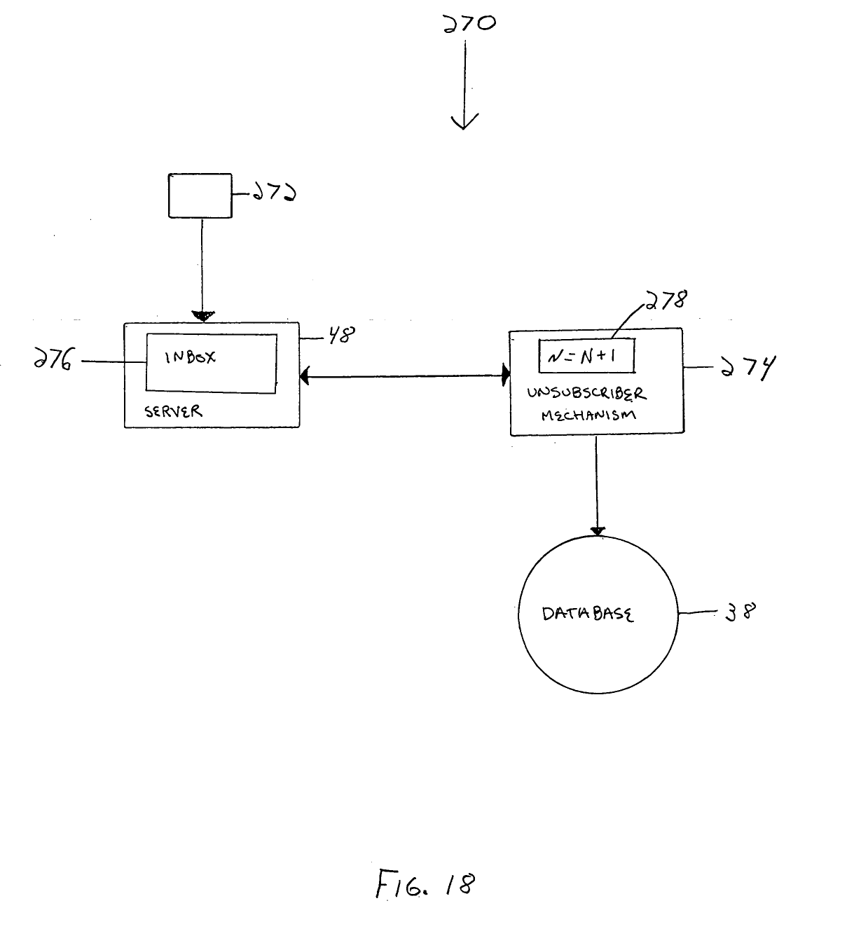

FIG. 18 shows a system 270 for un-subscribing users from the electronic publishing system 34. In particular, if a message is returned as undeliverable or if a user no longer wishes to receive informational messages, the system 270 allows the user to be removed as a subscriber. As shown, a message 272 is returned to the server 48. Within the server 48, the message 272 is placed in the inbox 276 of the publisher that sent the message 272 out. The un-subscriber mechanism 274 will routinely read the inbox and determine if a user should no longer receive messages. Specifically, if the message was undeliverable, the mechanism 274 will add one to a counter 278. Any users that exceed the limit for undeliverable messages (e.g., 1) will be unsubscribed. The limit for undeliverable messages can be set by either the publisher for the corresponding website or the administrator of the electronic publishing system 34. Moreover, any users that indicate a desire to be no longer receive messages can be un-subscribed as well. In either case, un-subscription takes place when the un-subscription mechanism 274 marks or “redflags” the user in the database 38. Preferably, the stored user data for the “red-flagged” user will remain in the database 38 in case the user wishes to re-subscribe at a later time. As shown in FIG. 18, the database 38 and server 48 are the same components that are depicted in FIGS. 2 and 3. However, it should be appreciated that a separate server could be used.

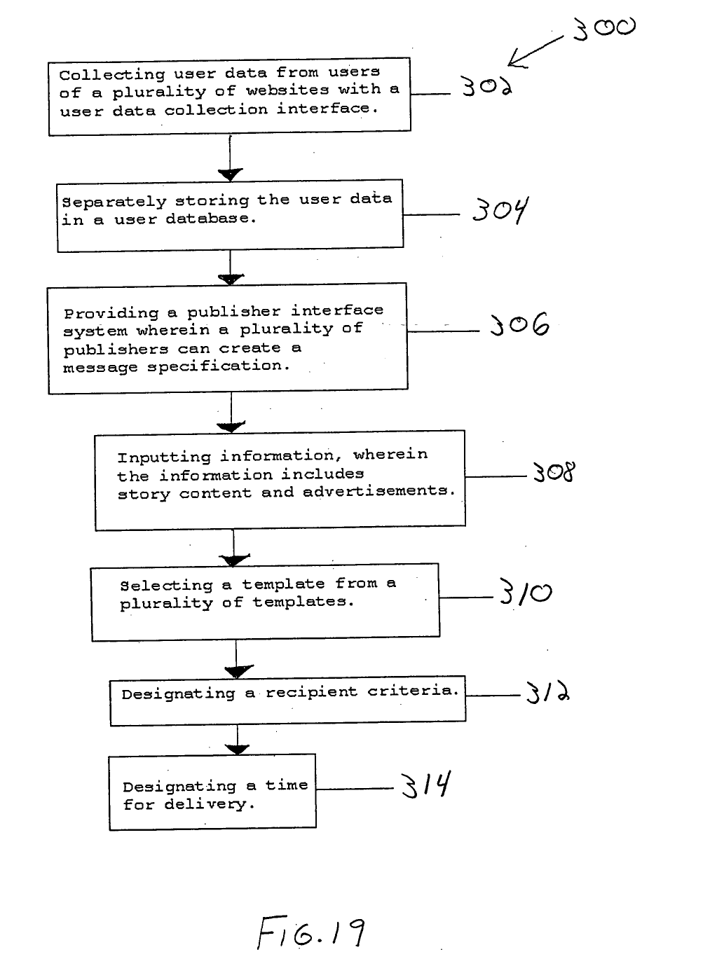

FIG. 19 shows a first method 300 in accordance with the present invention. In particular, the first step 300 of the method 300 is collecting user data from users of a plurality of websites. The second step 304 is storing the user data in a user data collection interface. The third step of the method 300 is providing the publisher interface system, wherein a plurality of publishers can create a message specification by: (a) inputting information 306, wherein the information includes story content and advertisements; (b) selecting a template from a plurality of templates 308, wherein the information will be displayed in the selected templates; (c) designating a recipient criteria of the website users that will receive the information 310; and (d) designating a time for delivery 312.

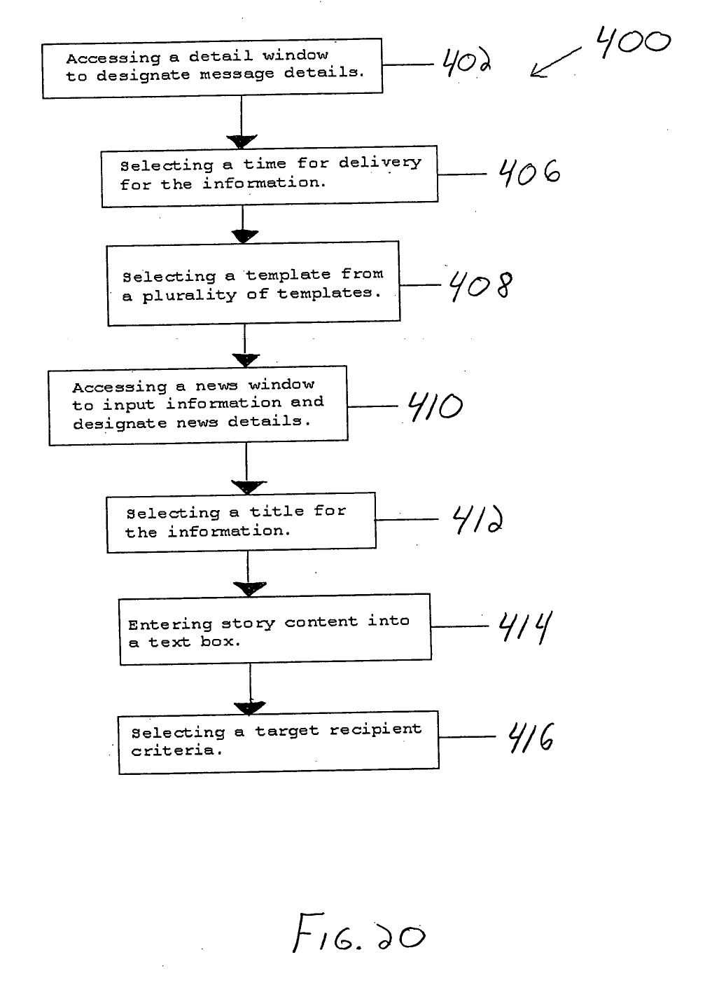

FIG. 20 shows a second method 400 in accordance with the present invention. The first step 402 of the method 400 is accessing a detail window to designate message details, including: (a) selecting a time for delivery for the information 404; and (b) selecting a template from a plurality of templates 406. The next step 408 of the method 400 is accessing a news window to input the information and designate news details, including: (a) selecting a title for the information 410; (b) inputting story content into a text box 412; and (c) selecting a target recipient criteria 414.

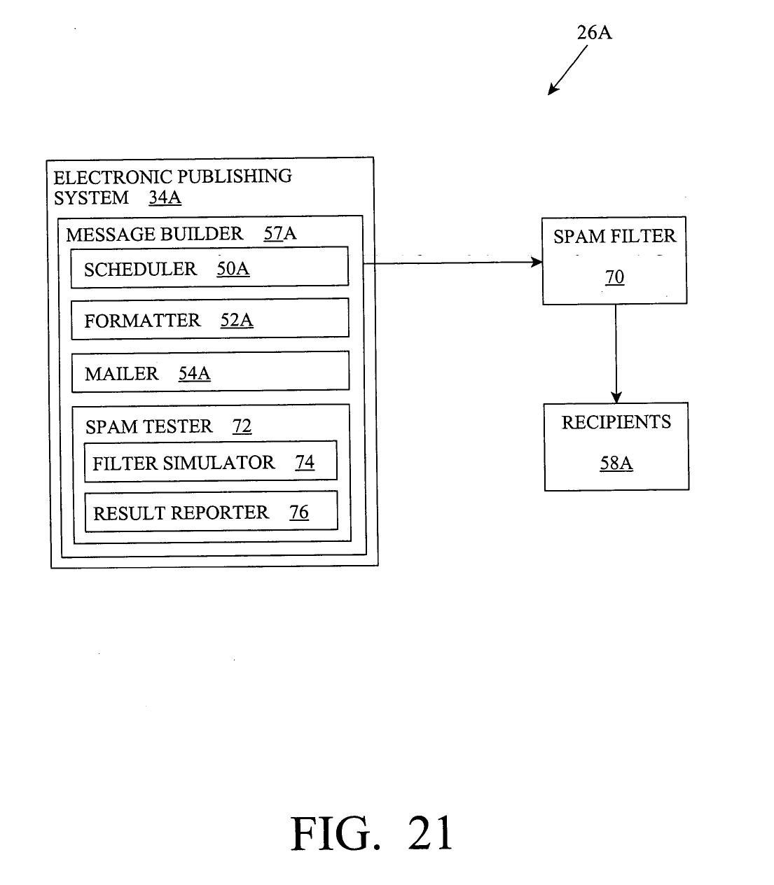

FIG. 21 shows a portion of an alternative electronic publishing environment 26A according to another aspect of the invention. Electronic publishing environment 26A includes an electronic publishing system 34A. It is understood that electronic publishing environment 26A and electronic publishing system 34A include the same components as those depicted in FIG. 2 for electronic publishing environment 26 and electronic publishing system 34. These components have not been separately shown and discussed in FIG. 21 for brevity purposes.

As shown, electronic publishing environment 26A further includes a spam filter 70 and a group of recipients 58A. Spam filter 70 represents any type of spam filtering software now known or later developed. Specifically, spam filter 70 receives a message sent to one or more recipients 58A and determines whether the message is likely to be spam. If spam filter 70 determines that the message is likely to be spam, it may block the message, reject the message, mark the message as spam, etc. If spam filter 70 determines that the message is not likely to be spam, then the message can be delivered to the one or more recipients 58A.

As noted previously, spam filter 70 may mistakenly determine that a message desired by one or more recipients 58A is spam. Consequently, a message that is sent to one or more recipients 58A by message builder 57A may be mistakenly determined to be spam by spam filter 70. To prevent this, message builder 57A includes spam tester 72 in addition to scheduler 50A, formatter 52A, and mailer 54A. Spam tester 72 assesses whether a message generated by formatter 52A is likely to be flagged as spam. To this end, spam tester 72 includes a filter simulator 74 and a result reporter 76.

Filter simulator 74 assesses one or more attributes of the message to determine if the message is likely to be flagged as spam. The attributes of the message that are assessed can include its title, the type of salutation (if any), the presence of any key words and/or key phrases, the overall format of the message, the length of the message, the inclusion of any links, email addresses, or files, etc. Filter simulator 74 can assign a spam value to each attribute based on the message. Result reporter 76 provides a spam assessment for the message based on the assessed attributes of the message. In response to the spam assessment, the website publisher can alter the message, alter a template used to generate the message, keep the message, etc.

While the invention is described as including a filter simulator 74, it is understood that filter simulator 74 can comprise a commercially available spam filter software product. In this case, mailer 54A can send a test message to the spam filter software product to determine whether it is likely to be flagged as spam. Result reporter 76 could then provide an interface for analyzing the results of the spam filter software product within spam tester 72, and presenting the various options to the website publisher. Alternatively, spam tester 72 could comprise a spam filter software product, and any necessary user interface, i.e., result reporter 76, could be integrated as part of mailer 54A. Still further, filter simulator 74 and/or spam tester 72 can comprise multiple spam filter software products, a spam filter simulator, or any combination of the two.

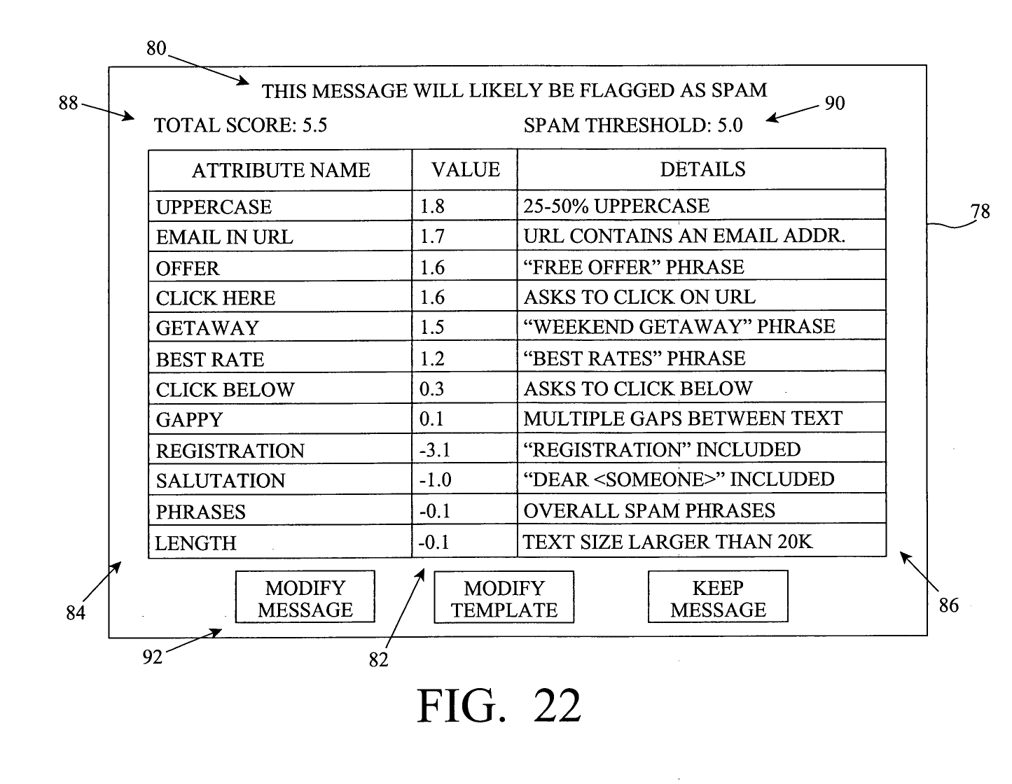

FIG. 22 depicts an illustrative results window 78 generated by result reporter 76 (FIG. 21). Results window 78 includes a spam assessment 80 of the message. Spam assessment 80 is based on spam values 82 assigned to attributes 84 of the message. In this embodiment, spam values 82 fall within a range of positive and negative values. Based on an analysis of each attribute 84, filter simulator 74 (FIG. 21) assigns a negative spam value 82 if attribute 84 makes the message less likely to be spam, a positive spam value 82 if attribute 84 makes the message more likely to be spam, and a spam value 82 of zero if attribute 84 is not relevant or does not have a net effect on the likelihood of the message being spam. Results window 78 includes a chart that lists in each row an attribute 84 that was assigned a non-zero spam value 82, its corresponding spam value 82, and details 86 of how spam value 82 was obtained. Attributes 84 are ordered in descending order of spam values 82. It is understood that attributes 84, spam values 82, details 86, and the selection, format, and order in which each is shown are only illustrative of the various possible embodiments of the information.

To determine if the message is likely to be flagged as spam, filter simulator 74 (FIG. 21) sums spam values 82 to obtain a “total” spam score 88 for the message. Spam score 88 is then compared to a spam threshold value 90. When spam score 88 exceeds spam threshold value 90, result reporter 76 (FIG. 21) reports that the message is likely to be flagged as spam. Based on spam assessment 80 and/or spam score 88, the website publisher may select one of various options 92 for the message. In particular, the website publisher may choose to modify the message, modify the template used to create the message, and/or keep the message.

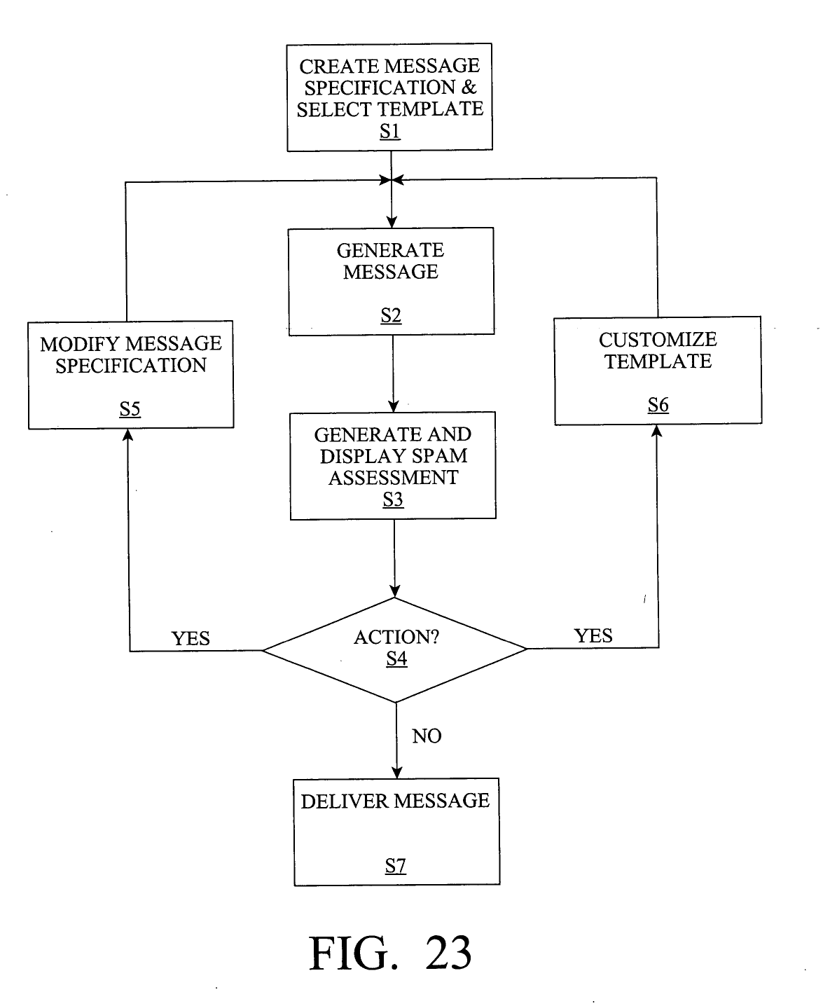

FIG. 23 depicts an illustrative flow chart for electronically publishing information in accordance with the present invention. In step S1, the website publisher creates a message specification and selects a template for the message. In step S2, the message is generated based on the message specification and the template. The generated message can incorporate a story, advertisement, etc. and can be formatted using a template as discussed above. In step S3, the likelihood that the message will be flagged as spam is assessed. This can include, for example, assigning spam values to attributes of the message, obtaining a spam score for the message by summing the spam values, and determining if the message is likely to be flagged as spam by comparing the spam score to a spam threshold value. The spam assessment for the message is then displayed to the website publisher.

In step S4, the website publisher decides on a desired action based on the spam assessment. When the message is likely to be flagged as spam, or the spam score is higher than the website publisher desires, one or more of the attributes of the message can be adjusted. In step S5, attributes of the message are adjusted by modifying the message specification. In step S6, attributes of the message are adjusted by customizing the template used to generate the message. After either step S5 or step S6 completes, the message is regenerated in step S2 and the likelihood of being flagged as spam is reassessed in step S3. After the website publisher decides to keep the message, the message is delivered to the selected recipients in step S7. It is understood that the various method steps depicted are only illustrative of the invention. As a result, more or fewer steps can be performed, the order of the steps can be altered, etc.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. An electronic publishing system, comprising:
a publisher interface that allows a publisher of a website to create a message specification associated with the website; and
a message builder that generates a message for delivery to a targeted group of users of the website based on the message specification, wherein the message builder includes:
a formatter for generating the message; and
a spam tester for assessing whether the message is likely to be flagged as spam.

2. The system of claim 1, wherein the spam tester includes:
a filter simulator that assesses attributes of the message; and
a result reporter that provides a spam assessment for the message based on the assessed attributes of the message.

3. The system of claim 2, wherein the filter simulator assigns a spam value to each attribute of the message, and sums the spam values to determine if the message is likely be flagged as spam.

4. The system of claim 3, wherein the score reporter displays the spam values assigned to at least some of the attributes.

5. The system of claim 1, further comprising:
a data collection interface for collecting user data from users of a plurality of websites; and
a database for separately storing collected user data for each website, wherein the targeted group of users is selected from the user data stored for the website.

6. The system of claim 1, wherein the publisher interface includes:
a mechanism for selecting a template from a plurality of templates, wherein the formatter generates the message using the selected template;
a mechanism for inputting information;
a mechanism for designating a recipient criteria; and
a scheduling mechanism for establishing a delivery time for the message.

7. The system of claim 6, wherein the message builder further includes:
a scheduler for grouping an advertisement with story content and for determining specific users that will receive the message based on the recipient criteria; and
a mailer for delivering the message at the established delivery time.

8. The system of claim 6, wherein the publisher interface further includes a mechanism for choosing from a plurality of delivery modes.

9. The system of claim 1, further comprising a system for un-subscribing users, wherein unsubscribed users will not receive the message.

10. A method of electronically publishing information, comprising:
creating a message specification associated with a website;
generating a message based on the message specification;
assessing whether the message is likely to be flagged as spam; and
delivering the message to a targeted group of users.

11. The method of claim 10, wherein the assessing step includes:
assigning a spam value to each of a plurality of attributes of the message;
obtaining a spam score for the message by summing the spam values; and
determining if the message is likely to be flagged as spam by comparing the spam score to a spam threshold value.

12. The method of claim 10, further comprising:
adjusting at least one of the attributes of the message when the message is likely to be flagged as spam; and
assessing whether the adjusted message is likely to be flagged as spam.

13. The method of claim 10, further comprising:
collecting user data from users of a plurality of websites;
separately storing the user data for each website in a database, wherein the targeted group of users is selected from the user data stored for the website.

14. The method of claim 10, further comprising:
selecting a template from a plurality of templates;
inputting information for the message, wherein the message is generated using the selected template and the inputted information;
designating a recipient criteria;
determining the targeted group of users based on the recipient criteria;
choosing a delivery mode from a plurality of delivery modes; and
establishing a delivery time for the message.

15. The method of claim 14, further comprising customizing the selected template when the message generated using the selected template is likely to be flagged as spam.

16. A program product stored on a recordable media for electronically publishing information, the program product comprising:
program code configured to allow a publisher of a website to create a message specification associated with the website;
program code configured to generate a message for delivery to a targeted group of users of the website based on the message specification; and
program code configured to assess whether the message is likely to be flagged as spam.

17. The program product of claim 16, wherein the program code configured to assess the message includes:
program code configured to assign a spam value for each of a plurality of attributes of the message;
program code configured to obtain a spam score for the message based on the spam values; and
program code configured to determine if the message is likely to be flagged as spam based on the spam score.

18. The program product of claim 16, further comprising:
program code configured to select a template from a plurality of templates;
program code configured to input information for the message, wherein the message is generated using the selected template and the inputted information;
program code configured to designate a recipient criteria;
program code configured to determine the targeted group of users based on the recipient criteria;
program code configured to choose a delivery mode from a plurality of delivery modes; and
program code configured to establish a delivery time for the message.

19. The program product of claim 18, further comprising program code configured to customize the selected template.

20. The program product of claim 16, further comprising:
program code configured to adjust an attribute of the message when the message is likely to be flagged as spam; and
program code configured to assess whether the adjusted message is likely to be flagged as spam.
